(19) United States
(12) Patent Application Publication
(10) Pub. No.: US 2022/0117242 A1
(43) Pub. Date: Apr. 21, 2022

(54) Brown rice oat bread with low glycemic index and preparation method thereof

(71) Applicant: Jiangnan University, Wuxi (CN)

(72) Inventors: Li WANG, Wuxi (CN); Qifeng PAN, Wuxi (CN); Juan SUN, Wuxi (CN); Yan LI, Wuxi (CN); Haifeng QIAN, Wuxi (CN); Guoliang CAO, Wuxi (CN); Hongliang CAO, Wuxi (CN)

(21) Appl. No.: 17/561,769

(22) Filed: Dec. 24, 2021

(51) Int. Cl. A21D 13/047; A21D 2/26; A21D 2/16; A21D 2/02; A21D 8/04; A21D 13/06

(52) U.S. Cl. CPC A21D 13/047; A21D 2/265; A21D 2/165; A21D 13/06; A21D 2/02; A21D 8/047; A21D 2/263

(57) ABSTRACT

The present disclosure discloses a brown rice and oat bread with low glycemic index and a preparation method thereof, which belongs to the technical field of grain processing. The brown rice and oat bread provided by the present disclosure includes the following ingredients: brown rice flour, gluten powder, oat flour, butter, sodium caseinate, salt, yeast, improver, and water. According to the present disclosure, the sodium caseinate is used to help form a dough and improve the flavor of the bread, and the brown rice and oat bread with low glycemic index is obtained with the brown rice bread recipe and special baking process, which is close to wheat bread in terms of specific volume, taste and tissue structure.

### TECHNICAL FIELD

The present disclosure belongs to the technical field of grain processing and relates to a brown rice and oat bread with low glycemic index and a preparation method thereof.

### BACKGROUND

Rough rice is the second largest cereal in the world, accounting for ⅕ of the total cereal area. In China, rough rice is grown in a wide range of regions and varieties, and China is the world's largest producer and consumer of rough rice, with about ⅔ of the population consuming rice as a staple food. Long-term consumption of white rice is one of the main causes of many chronic diseases (such as hyperglycemia, hypertension, constipation, and anemia) in modern people. Brown rice is the whole grain rice obtained from unprocessed or less processed rough rice after husking, which consists of three major parts: bran, embryo and endosperm. About 64% of the nutritional elements in the rough rice are gathered in the bran layer and germ. Compared with ordinary rice, brown rice retains the whole nutrient in rough rice to a higher degree. Brown rice not only contains more protein, fat, vitamins, minerals and other nutrients, but also contains dietary fiber, oryzanol, glutathione, γ-aminobutyric acid, rice bran polysaccharide, octacosanols, inositol and other functional factors that promote human health, especially for dietary fiber and B vitamins, the content of which is much higher than that of ordinary rice. Therefore, brown rice has more nutrition and health care functions than ordinary rice, and thus the market prospect is very broad. Oats are rich in starch, protein, insoluble dietary fiber, as well as oat β-glucan, avenanthramide, tocopherol and oat saponin, which are associated with reduced risk of diabetes, cardiovascular disease and other diseases. However, the disadvantage of poor taste of both makes it difficult to adapt to modern dining habits, and the acceptance of consumption as a staple food is low.

Bread is an important product form in bakery products. Since containing no gluten protein, brown rice and oats have difficulty in forming a network structure, difficulty in dough shaping, poor air-holding, and less pores inside the bread, and are easy to collapse as a whole. Therefore, the production of brown rice and oat bread with high brown rice and oat content requires the addition of a certain amount of gluten powder to supplement the gluten protein in the bread. Due to the high water-holding capacity of gluten protein, the exogenous supplementation of gluten powder will lead to an increase in the amount of water added to prepare bread. The addition amount of water is 55%-65% for typical wheat bread, while the addition amount of water is 80% or more for brown rice and oat bread with high brown rice and oat content. Excessive water addition amount causes starch to swell faster. During the baking process of brown rice and oat bread, the starch granules swell excessively, melt and gradually lose their integrity as the baking temperature rises, resulting in the formation of bubble chambers that are not permeable to air as compared to ordinary wheat flour, which would shrink due to low internal pressure during the cooling stage after baking, eventually causing the bread to shrink and collapse. This problem limits the amount of brown rice flour and oat flour used in baked goods. Therefore, the content of brown rice flour or oat flour in commercially available breads is mostly less than 30%.

### SUMMARY

The present disclosure provides a composite flour for making a bread, including: brown rice flour, gluten powder, oat flour, sodium caseinate, and improver. Further, in parts by mass, the brown rice flour is 45 to 55 parts, the gluten powder is 30 to 40 parts, the oat flour is 10 to 20 parts, the sodium caseinate is 3 to 6 parts, and the improver is 1 to 2 parts.

When making bread using the composite flour, 5 to 8 parts of butter, 1 to 2 parts of salt, 1 to 2 parts of yeast, and 90 to 100 parts of water are additionally added.

The present disclosure provides a brown rice and oat bread, the ingredients of which include: brown rice flour, gluten powder, oat flour, butter, sodium caseinate, salt, yeast, improver, and water. Further, in parts by mass, the brown rice flour is 45 to 55 parts, the gluten powder is 30 to 40 parts, the oat flour is 10 to 20 parts, the butter is 5 to 8 parts, the sodium caseinate is 3 to 6 parts, the salt is 1 to 2 parts, the yeast is 1 to 2 parts, the improver is 1 to 2 parts, and the water is 90 to 100 parts.

The brown rice flour has a starch content of 74.3%-76.4%, a protein content of 6.1%-7.3% and a fat content of 0.3%-0.5%. The oat flour has a starch content of 58.2%-60.5%, a protein content of 10.9%-11.3% and a fat content of 6.2%-6.6%. The gluten powder has a starch content of 79.4%-80.1%, a protein content of 15.3%-16.3% and a fat content of 1.4%-2.3%. The sodium caseinate has a protein content of 94.04%-96.66%, an emulsification activity index of 80.6-80.8, an emulsion stability index of 14.0-16.0, and a secondary structure β-fold content of 46.20%-52.04%.

In one embodiment of the present disclosure, the ratio of oat flour to gluten powder is 15 parts: 35 parts.

In one embodiment of the present disclosure, the ingredients of brown rice and oat bread include: 50 parts of brown rice flour, 35 parts of gluten powder, 15 parts of oat flour, 6 parts of butter, 3 parts of sodium caseinate, 1.6 parts of salt, 1 part of yeast, 1 part of improver, and 100 parts of water.

The present disclosure also provides a method for preparing the brown rice and oat bread, including the steps of:
weighing the brown rice flour, the gluten powder, the oat flour, the salt, the sodium caseinate, the improver and the yeast in parts by mass to prepare mixed flour; adding water to the mixed flour, stirring at a low speed for 5 min, then stirring at a high speed for 8 min until a dough is basically formed, adding the butter and kneading at a low speed until the gluten is fully developed to obtain a dough; shaping and plating the dough; allowing the dough after plating to rise at a humidity of 80% and a temperature of 38° C. for 1 h, then baking, and cooling at room temperature for 60 min to obtain the brown rice and oat bread product; for the baking, an upper fire temperature is 200-220° C., a bottom fire temperature is 190-210° C., and a baking time is 25-35 min. Optionally, the upper fire temperature is 220° C., the bottom fire temperature is 200° C., and the baking time is 30 min.

In one embodiment of the present disclosure, the dough is 250 g after plating.

The present disclosure provides a method for preparing a brown rice and oat bread which has a simple preparation process and does not require multiple fermentation and shaping, facilitating large-scale industrial production and reducing production costs.

According to the present disclosure, the sodium caseinate is used to help form the dough and improve the flavor of the bread, and the brown rice and oat bread with good quality is obtained with the brown rice bread recipe and process.

According to the present disclosure, the bread prepared from brown rice and oats has the function of small postprandial blood glucose fluctuation and maintaining the dynamic balance of postprandial blood glucose, which can not only increase the dietary choices of diabetic people, but also enrich the variety of brown rice and oat products, and thus can be a new way of using brown rice and oat resources.

According to the present disclosure, brown rice is taken as the main raw material (brown rice and oats account for more than 50% of the raw materials except water) and a certain content of gluten powder and oat flour is added to produce the bread that can effectively reduce the intake of starch and is rich in dietary fiber having a positive effect in controlling blood glucose.

According to the present disclosure, the bread with low glycemic index is prepared, and thus sucrose is not added in the recipe. However, sucrose is the main carbon source for yeast fermentation, and the lack of sucrose is not conducive to gas production from yeast, resulting in a small degree of dough expansion and a small specific volume of the bread as produced. The present disclosure intends to optimize the bread recipe and preparation process, and bake the brown rice and oat bread in a different way than normal bread to obtain a brown rice and oat bread, which is close to wheat bread in terms of specific volume, taste and tissue structure.

### BRIEF DESCRIPTION OF FIGURES

FIG. 1 shows an image of brown rice and oat breads prepared by rising at 30° C. for 50 min, 60 min, 70 min, and baking at an upper fire temperature of 220° C., and a bottom fire temperature 200° C. for a baking time of 30 min; the figure shows a wheat bread, a brown rice and oat bread rose for 50 min, a brown rice and oat bread rose for 60 min, and a brown rice and oat bread rose for 70 min from left to right.

FIG. 2 shows an image of brown rice and oat breads prepared by rising at 38° C. for 50 min, 60 min, 70 min, and baking at an upper fire temperature of 170° C., and a bottom fire temperature 190° C. for a baking time of 35 min; the figure shows a wheat bread, a brown rice and oat bread rose for 50 min, a brown rice and oat bread rose for 60 min, and a brown rice and oat bread rose for 70 min from left to right.

FIG. 3 shows an image of brown rice and oat breads prepared by rising at 38° C. for 50 min, 60 min, 70 min, and baking at an upper fire temperature of 220° C., and a bottom fire temperature 200° C. for a baking time of 30 min; the figure shows a wheat bread, a brown rice and oat bread rose for 50 min, a brown rice and oat bread rose for 60 min, and a brown rice and oat bread rose for 70 min from left to right.

FIG. 4 shows an image of brown rice and oat breads with different amounts of water addition; in the figure, a wheat bread is in the leftmost, and the 4 rows of breads on the right are brown rice and oat breads with a water addition amount of 79, 80, 90 and 100 parts respectively from top to bottom (3 slices in each row are parallel samples).

FIG. 5 is a curve showing change in human postprandial blood glucose concentration.

### DETAILED DESCRIPTION

As used in the following examples, brown rice is commercially available from Heilongjiang Sunbin Hongyuan Agricultural Development Group Co., Ltd.; oats are commercially available from Wuchang City Caiqiao Rice Industry Co., Ltd.; gluten powder is commercially available from Anhui Ante Food Co., Ltd., and the gluten powder has a starch content of 79.4%-80.1%, a protein content of 15.3%-16.3% and a fat content of 1.4%-2.3%; salt is commercially available from Foshan City Cengcenggao Food Co., Ltd.; butter is commercially available from New Zealand Fonterra Group; sodium caseinate is commercially available from Zhengzhou City Qianzhi Food Co., Ltd., sodium caseinate has a protein content of 94.04%-96.66%, an emulsification activity index of 80.6-80.8, an emulsion stability index of 14.0-16.0, and a secondary structure β-fold content of 46.20%-52.04%; improver is commercially available as model 5500 from Guangzhou Puratos Food Co., Ltd.; and high sugar yeast is commercially available from Angel Yeast Co. Ltd.

The brown rice flour is prepared by placing brown rice raw materials into a container, rinsing the brown rice, drying at room temperature, crushing in an airflow conveying dry powder system at room temperature, and passing the obtained brown rice flour through an 80 mesh sieve to obtain the brown rice flour. The brown rice flour has a starch content of 74.3%-76.4%, a protein content of 6.1%-7.3%, and a fat content of 0.3%-0.5%.

The oat flour is prepared by placing brown rice raw materials into a container, rinsing the oat grains, steaming the oat grains at 100° C. for 30 min, then drying, crushing in an airflow conveying dry powder system at room temperature, and passing the obtained oat flour through an 80 mesh sieve to obtain the oat flour. The oat flour has a starch content of 58.2%-60.5%, a protein content of 10.9%-11.3% and a fat content of 6.2%-6.6%.

See Table 1 for sensory evaluation criteria for brown rice and oat bread.

TABLE 1

| Item | Sensory evaluation score criteria | Score |
|---|---|---|
| Specific | 5.0 cm³/g for full score, deducting | 20 |
| volume | 1 point for every 0.2 less | |
| Morphology | Complete, no defects, cracks, dents | 13~16 |
| | and bumps, smooth surface | |
| | Complete, no defects, slight | 8~12 |
| | white powder and spots | |
| | defects, obvious cracks, | 0~7 |
| | and not smooth surface | |
| Color | Golden yellow, uniform | 13~16 |
| | color, no burnt and white | |
| | Light yellow surface, uneven color | 8~12 |
| | Burnt and white surface | 0~7 |
| Odor | Full aroma with oatmeal characteristics | 13~16 |
| | Lighter bread aroma | 8~12 |
| | No bread aroma or smelly | 0~7 |
| Taste | Soft and palatable, no teeth- | 13~16 |
| | sticking, no foreign taste, no | |
| | unmelted sugar or salt particles | |
| | Soft, slightly gritty | 8~12 |
| | Rough taste, foreign taste, teeth-sticking | 0~7 |
| Tissue | Fine tissue, elastic, uniform stomata | 13~16 |
| | size on the cut surface, clear texture | |
| | Uneven stomata on the cut surface, | 8~12 |
| | no obvious large holes and | |
| | local over-hardness, messy texture | |
| | Obviously large stomata, local over- | 0~7 |
| | hardness, fractured and slagged slices | |

### EXAMPLE 1

(1) In parts by mass, 50 parts of brown rice flour and 50 parts of oat flour and gluten powder (the ratio of oat flour to gluten powder was 25 parts: 25 parts, 20 parts: 30 parts, 15 parts: 35 parts, and 10 parts: 40 parts, respectively), 1.6 parts of salt, 1 part of yeast, and 1 part of improver were weighed to prepare mixed flour.

(2) 100 parts of water were added to the mixed flour, stirred at a low speed for 5 min, then stirred at a high speed for 8 min until a dough was basically formed, 6 parts of butter was added and kneaded at a low speed until the gluten was fully developed to obtain a dough.

(3) The dough was shaped and plated, and the dough was 250 g after plating.

(4) The dough after plating was allowed to rise at a humidity of 80% and a temperature of 38° C. for 1 h, then baked and cooled at room temperature for 60 min to obtain the brown rice and oat bread product, where for the baking, an upper fire temperature was 220° C., a bottom fire temperature was 200° C., and a baking time was 30 min, and the finished brown rice and oat bread was obtained.

The related results are shown in Tables 2 and 3. From Table 2, it can be seen that the gluten powder content has a certain improvement effect on the specific volume and structure of the brown rice and oat bread, in which the ratio of oat flour to gluten powder of 15 parts: 35 parts is more effective. At the same time, it can be seen that the brown rice and oat bread with the ratio of oat flour to gluten powder of 15 parts: 35 parts is closest to the control wheat bread in terms of specific volume, hardness, elasticity and recovery. As wheat protein concentrate, the gluten powder contains a large amount of glutenin and gliadin, which has good viscoelasticity and can form a gluten network structure in the dough, while the brown rice and oat protein do not have this property. The addition of gluten powder in the mixed flour makes up for the deficiency of glutenin and gliadin to a certain extent, which can enhance the strength of the mixed flour and form a stronger network structure, thus improving the extension ability and air-holding performance of the dough, thereby increasing the volume and reducing the hardness of the bread. The brown rice and oat bread with the ratio of oat flour to gluten powder of 10 parts: 40 parts has a decreased specific volume and an increased hardness compared with the brown rice and oat bread with the ratio of oat flour to gluten powder of 15 parts: 35 parts, which may be related to the excessive bread strength hindering the height of the rising dough.

From the sensory evaluation results in Table 3, it can be seen that the brown rice and oat bread with 25 and 30 parts of gluten powder improves the taste and internal structure of the bread to a certain extent. The bread has a soft and elastic core, increased pores, and more uniform and dense internal structure, in which the brown rice and oat bread with the ratio of oat flour to gluten powder of 15 parts: 35 parts has the highest total sensory evaluation score. Therefore, it is preferred that the ratio of oat flour to gluten powder of 15 parts: 35 parts is used to improve the quality of bread.

TABLE 2

| Ratio of | | | | | |
|---|---|---|---|---|---|
| oat flour | Specific | | | | |
| to gluten | volume | Hardness | | | |
| powder | (mL/g) | (g) | Elasticity | Chewability | Recovery |
| Wheat Bread | 4.42 | 275 | 0.958 | 209 | 0.421 |
| 25:25 | 3.49 | 704 | 0.777 | 270 | 0.178 |
| 20:30 | 3.79 | 599 | 0.794 | 264 | 0.219 |
| 15:35 | 4.16 | 377 | 0.969 | 283 | 0.441 |
| 10:40 | 3.93 | 462 | 0.936 | 313 | 0.385 |

TABLE 3

| Ratio of oat | Sensory indicator | | | | | | |
|---|---|---|---|---|---|---|---|
| flour to gluten | Specific | | | | | | Total |
| powder | volume | Morphology | Color | Odor | Taste | Tissue | score |
| Wheat Bread | 17.1 | 14.0 | 13.2 | 14.2 | 14.0 | 15.0 | 87.5 |
| 25:25 | 12.5 | 5.6 | 8.4 | 10.6 | 6.4 | 10.8 | 54.3 |
| 20:30 | 14.0 | 6.8 | 8.4 | 10.4 | 6.6 | 10.6 | 56.8 |
| 15:35 | 15.8 | 11.6 | 9.2 | 12.6 | 12.8 | 13.8 | 75.8 |
| 10:40 | 14.7 | 11.8 | 8.6 | 12.4 | 12.2 | 13.2 | 72.9 |

### EXAMPLE 2

(1) In parts by mass, 50 parts of brown rice flour, 35 parts of gluten powder, 15 parts of oat flour, 1.6 parts of salt, 1 part of yeast, and 1 part of improver were weighed to prepare mixed flour.

(2) 100 parts of water were added to the mixed flour, stirred at a low speed for 5 min, then stirred at a high speed for 8 min until a dough was basically formed, 6 parts of butter was added and kneaded at a low speed until the gluten was fully developed to obtain a dough.

(3) The dough was shaped and plated, and the dough was 250 g after plating.

(4) The dough after plating was respectively allowed to rise at a humidity of 80% and a temperature of 30° C. or 38° C. for 50 min, 60 min and 70 min, then baked and cooled at room temperature for 60 min to obtain the brown rice and oat bread product, where for the baking, an upper fire temperature was 220° C., a bottom fire temperature was 200° C., and a baking time was 30 min.

The related results are shown in FIGS. 1 and 3. FIG. 1 shows the brown rice and oat breads prepared by rising at 30° C. for 50 min, 60 min and 70 min. FIG. 3 shows the brown rice and oat breads prepared by rising at 38° C. for 50 min, 60 min and 70 min. It can be found that the specific volume of the bread is small upon using the conventional rising temperature for ordinary bread, because this brown rice and oat bread does not contain sucrose and the general rising temperature is not conducive to gas production from yeast.

From FIG. 3, it can be seen that when the fermentation temperature is 38° C., the specific volume of bread reaches the maximum at 60 min of rising time compared with the bread with a rising time of 50 min, this is probably because sufficient rising time allows the gluten protein network structure of the dough to stretch, allows the air-holding performance of the dough to be good, and allows the gas production from yeast to be sufficient, which is conducive to the rapid expansion of the volume of bread in the pre-baking period. When the rising time of the bread is 70 min, the specific volume of the bread is decreased, this is probably because the gluten network structure is destroyed by the excessive gas production from yeast, resulting in the collapse of the bread. In terms of texture, the brown rice and oat bread with a rising time of 60 min is closest to the control wheat bread in terms of hardness, elasticity, chewability and recovery.

From the sensory evaluation results in Table 5, it can be seen that the brown rice and oat bread with a rising time of 60 min has the highest total sensory evaluation score. Sufficient rising time allows the bread to be soft, have fine tissue, be elastic, have uniform stomata size on the cut surface and clear texture. Therefore, it is preferred that a rising condition of 38° C. and 60 min is used to improve the quality of bread.

TABLE 4

| | Specific | | | | |
|---|---|---|---|---|---|
| Rising time | volume | Hardness | | | |
| (min) | (mL/g) | (g) | Elasticity | Chewability | Recovery |
| Wheat Bread | 4.42 | 275 | 0.958 | 209 | 0.421 |
| 50 | 3.66 | 527 | 0.957 | 438 | 0.401 |
| 60 | 4.16 | 377 | 0.969 | 283 | 0.441 |
| 70 | 3.99 | 450 | 0.960 | 387 | 0.427 |

TABLE 5

| | Sensory indicator | | | | | | |
|---|---|---|---|---|---|---|---|
| Rising time | Specific | | | | | | Total |
| (min) | volume | Morphology | Color | Odor | Taste | Tissue | score |
| Wheat Bread | 17.1 | 14.0 | 13.2 | 14.2 | 14.0 | 15.0 | 87.5 |
| 50 | 13.3 | 10.4 | 8.4 | 12.2 | 11.0 | 10.4 | 65.7 |
| 60 | 15.8 | 11.6 | 9.2 | 12.6 | 12.8 | 13.8 | 75.8 |
| 70 | 15.0 | 11.0 | 9.0 | 12.4 | 11.2 | 11.4 | 70.0 |

### EXAMPLE 3

(1) In parts by mass, 50 parts of brown rice flour, 35 parts of gluten powder, 15 parts of oat flour, several parts of sodium caseinate, 1.6 parts of salt, 1 part of yeast, and 1 part of improver were weighed to prepare mixed flour.

(2) 100 parts of water were added to the mixed flour, stirred at a low speed for 5 min, then stirred at a high speed for 8 min until a dough was basically formed, 6 parts of butter was added and kneaded at a low speed until the gluten was fully developed to obtain a dough.

(3) The dough was shaped and plated, and the dough was 250 g after plating.

(4) The dough after plating was allowed to rise at a humidity of 80% and a temperature of 38° C. for 1 h, then baked and cooled at room temperature for 60 min to obtain the brown rice and oat bread product, where for the baking, an upper fire temperature was 220° C., a bottom fire temperature was 200° C., and a baking time was 30 min.

0, 1.5, 3 and 4.5 parts of sodium caseinate were respectively added to prepare the finished brown rice and oat bread. The related results are shown in Table 6. From Table 6, it can be seen that the specific volume of brown rice and oat bread with the addition of 1.5 and 3 parts of sodium caseinate is increased slightly, which may be related to the ability of sodium caseinate to increase the water absorption of the dough and improve the stirring stability and fermentation stability of the dough; however, the addition of excessive sodium caseinate also results in a decrease in the volume of the bread, which may be related to the fact that excessive sodium caseinate affects the fermentation performance of the yeast. The addition of sodium caseinate helps to improve the odor of bread, which is related to the odor of sodium caseinate itself. In addition, sodium caseinate helps to mask the bitterness of gluten powder in bread. The brown rice and oat bread with the addition of 3 parts of sodium caseinate has the highest total sensory evaluation score. Therefore, it is preferred that the addition of 3 parts of sodium caseinate is used to improve the quality of bread.

TABLE 6

| Addition amount | Sensory indicator | | | | | | |
|---|---|---|---|---|---|---|---|
| of sodium | Specific | | | | | | Total |
| caseinate | volume | Morphology | Color | Odor | Taste | Tissue | score |
| Wheat Bread | 17.1 | 14.0 | 13.2 | 14.2 | 14.0 | 15.0 | 87.5 |
| 0 | 15.8 | 11.6 | 9.2 | 12.6 | 12.8 | 13.8 | 75.8 |
| 1.5 parts | 16.0 | 11.0 | 9.0 | 13.0 | 12.8 | 12.8 | 74.6 |
| 3.0 parts | 16.0 | 12.4 | 9.6 | 13.8 | 13.4 | 13.4 | 78.6 |
| 4.5 parts | 15.5 | 11.4 | 9.2 | 13.2 | 12.0 | 12.8 | 74.1 |

### EXAMPLE 4

(1) In parts by mass, 50 parts of brown rice flour, 35 parts of gluten powder, 15 parts of oat flour, 3 parts of sodium caseinate, 1.6 parts of salt, 1 part of yeast, and 1 part of improver were weighed to prepare mixed flour.

(2) Several parts of water (70, 80, 90 or 100 parts) were added to the mixed flour, stirred at a low speed for 5 min, then stirred at a high speed for 8 min until a dough was basically formed, 6 parts of butter was added and kneaded at a low speed until the gluten was fully developed to obtain a dough.

(3) The dough was shaped and plated, and the dough was 190 g after plating.

(4) The dough after plating was allowed to rise at a humidity of 80% and a temperature of 38° C. for 1 h, then baked and cooled at room temperature for 60 min to obtain the brown rice and oat bread product, where for the baking, an upper fire temperature was 220° C., a bottom fire temperature was 200° C., and a baking time was 30 min, and the finished brown rice and oat bread was obtained.

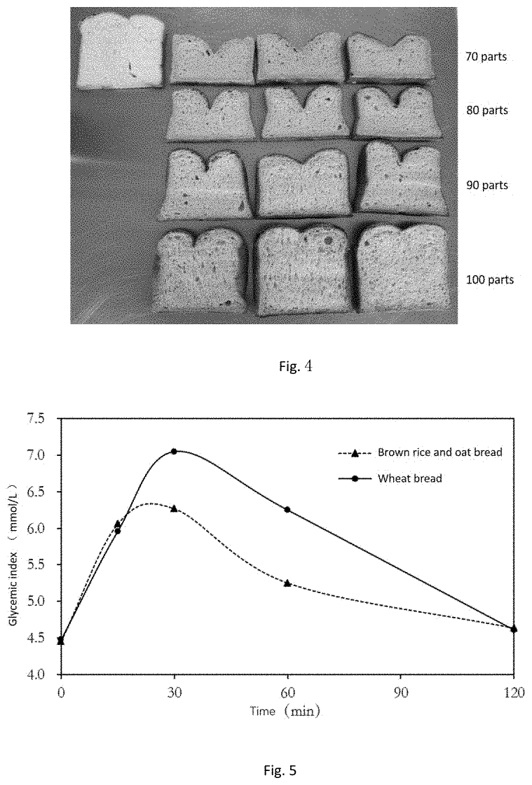

The related results are shown in FIG. 4, and it can be found that the brown rice and oat bread made according to the general water addition for wheat bread has a small specific volume and firm bread tissue, which is related to the fact that the insufficient water addition allows the dough to have a large hardness and too strong tensile resistance, which is not conducive to the expansion of the dough. As the amount of water added to the bread increases, the specific volume of the bread increases, the core structure of the bread is improved and the stomata are evenly distributed. Therefore, it is preferred that the addition of 100 parts of water is used to improve the quality of bread.

### EXAMPLE 5

(1) In parts by mass, 50 parts of brown rice flour, 35 parts of gluten powder, 15 parts of oat flour, several parts of sodium caseinate, 1.6 parts of salt, 1 part of yeast, and 1 part of improver were weighed to prepare mixed flour.

(2) 100 parts of water were added to the mixed flour, stirred at a low speed for 5 min, then stirred at a high speed for 8 min until a dough was basically formed, 6 parts of butter was added and kneaded at a low speed until the gluten was fully developed to obtain a dough.

(3) The dough was shaped and plated, and the dough was 190 g after plating.

(4) The dough after plating was allowed to rise at a humidity of 80% and a temperature of 38° C. for 1 h, then baked and cooled at room temperature for 60 min to obtain the brown rice and oat bread product, where the upper fire temperature, the bottom fire temperature, and the baking time were shown in Table 7.

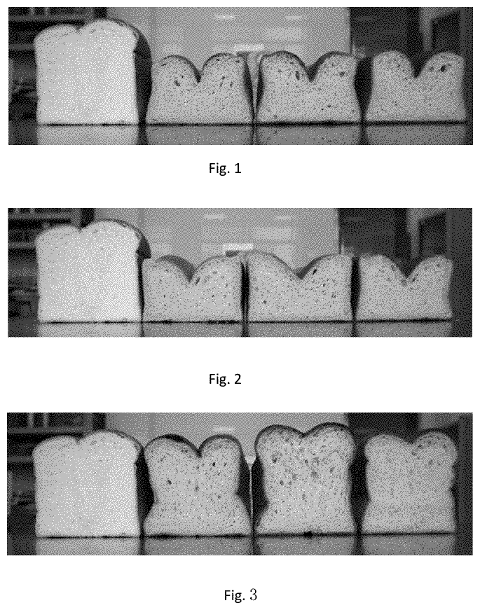

The related results of the finished brown rice and oat bread as prepared under different baking conditions are shown in Table 7. From Table 7, it can be seen that the brown rice and oat bread prepared at a baking temperature for conventional bread is prone to collapse, this is because late starch pasting in the bread is not conducive to the shaping of the bread, leads to excessive expansion of the bread in the pre-baking period and destroys the strength of the network structure of the bread during baking. FIG. 2 shows the brown rice and oat bread prepared with the upper fire temperature of 170° C., the bottom fire temperature of 190° C. and the baking time of 35 min. Compared with the wheat bread with the same baking conditions, this brown rice and oat bread collapsed seriously. FIG. 3 shows the brown rice and oat bread prepared at the upper fire temperature of 220° C., and the bottom fire temperature of 200° C. for the baking time of 30 min, this bread has no obvious collapse. According to the present disclosure, the upper fire temperature is higher than the bottom fire temperature, which is conducive to the rapid outward migration of moisture in the bread, while the high baking temperature helps the bread to quickly expand and shape, allows the obtained crust to be brittle and prevents the bread from collapsing. However, if the baking temperature is too high, the surface color of the bread will turn black and the smell of burnt food will be produced due to the Maillard reaction. Therefore, it is preferred that an upper fire temperature for baking of 220° C., a bottom fire temperature for baking of 200° C., and a baking time of 30 min are used to improve the quality of bread.

TABLE 7

| | Upper fire | Bottom fire | | | | |
|---|---|---|---|---|---|---|
| | temperature | temperature | Baking | Specific | | Color |
| | for baking | for baking | time | volume | Degree of | of |
| | (° C.) | (° C.) | (min) | (cm³/g) | collapse | crust |
| Test 1 | 170 | 190 | 35 | 3.6 | Serious | — |
| Test 2 | 170 | 190 | 40 | 3.6 | Serious | — |
| Test 3 | 190 | 210 | 30 | 4.0 | Moderately | — |
| | | | | | serious | |
| Test 4 | 190 | 210 | 35 | 4.2 | Moderately | — |
| | | | | | serious | |
| Test 5 | 220 | 200 | 30 | 4.2 | No | Moder- |
| | | | | | | ately |
| | | | | | | dark |
| Test 6 | 220 | 210 | 30 | 4.2 | No | Dark |

### EXAMPLE 6

(1) In parts by mass, 50 parts of brown rice flour, 35 parts of gluten powder, 15 parts of oat flour, 3 parts of sodium caseinate, 1.6 parts of salt, 1 part of yeast, and 1 part of improver were weighed to prepare mixed flour.

(2) 100 parts of water were added to the mixed flour, stirred at a low speed for 5 min, then stirred at a high speed for 8 min until a dough was basically formed, 6 parts of butter was added and kneaded at a low speed until the gluten was fully developed to obtain a dough.

(3) The dough was shaped and plated, and the dough was 250 g after plating.

(4) The dough after plating was allowed to rise at a humidity of 80% and a temperature of 38° C. for 1 h, then baked and cooled at room temperature for 60 min to obtain the brown rice and oat bread product, where for the baking, an upper fire temperature was 220° C., a bottom fire temperature was 200° C., and a baking time was 30 min.

(5) The subjects were 11 healthy volunteers, including seven females and four males, aged between 22-27 years, with BMI 19-23 kg/m2, regular diet and work and rest habits, no family history of metabolic diseases and chronic diseases, no recent history of medication and gastrointestinal digestive diseases, no smoking and no alcohol. The subjects were fasted for solids and liquids 12 h before the experiment. On the day of the experiment, the subjects walked slowly to the laboratory and were measured for fasting blood glucose concentration by fingertip blood collection. The subjects ate 70 g of brown rice and oat breads within 10 min. The time was recorded at the beginning of the meal and the postprandial blood glucose concentration was measured by fingertip blood collection at 15, 30, 60 and 120 min after the meal. During the experiment, the subjects were fasted for solids and liquids and engaged in light physical activity. The curve showing the change in human postprandial blood glucose concentration was plotted with the time as the horizontal coordinate and the change in blood glucose concentration of the subjects as the vertical coordinate.

The changes in human blood glucose concentration after the consumption of brown rice and oat bread prepared by the optimal process are shown in FIG. 5. As can be seen from FIG. 5, the blood glucose concentration is increased slowly after the consumption of brown rice and oat bread as compared to the control wheat bread. The peak postprandial blood glucose for both appears at 30 min. Compared with the wheat bread, the postprandial blood glucose concentration is decreased slowly after reaching the peak blood glucose level for the brown rice and oat bread. This indicates that the brown rice and oat bread induces a small postprandial blood glucose fluctuation and has a strong ability to maintain the dynamic balance of postprandial blood glucose. The GI value of the brown rice and oat bread is 49.

What is claimed is:

1. A method for preparing a bread, wherein the bread is a brown rice and oat bread with low glycemic index, the raw materials comprise: 45 to 55 parts of brown rice flour, 30 to 40 parts of gluten powder, 10 to 20 parts of oat flour, 5 to 8 parts of butter, 3 to 6 parts of sodium caseinate, 1 to 2 parts of salt, 1 to 2 parts of yeast, 1 to 2 parts of improver, and 90 to 100 parts of water;
and the method comprises the steps of weighing the brown rice flour, the gluten powder, the oat flour, the salt, the sodium caseinate, the improver and the yeast in parts by mass to prepare mixed flour, adding water to the mixed flour, stirring until a dough is formed, adding butter and kneading to obtain a dough; shaping and plating the dough; allowing the dough after plating to rise at a humidity of 80% and a temperature of 38° C. for 1 h, then baking, and cooling at room temperature to obtain the brown rice and oat bread product; for the baking, an upper fire temperature is 200-220° C., a bottom fire temperature is 190-210° C., and a baking time is 25-35 min.

2. The method for preparing a bread according to claim 1, wherein the upper fire temperature is 220° C., the bottom fire temperature is 200° C. and the baking time is 30 min.

3. The method for preparing a bread according to claim 1, wherein the ratio of oat flour to gluten powder is 15 parts: 35 parts.

4. The method for preparing a bread according to claim 1, wherein the water is 100 parts.

5. The method for preparing a bread according to claim 1, wherein the brown rice flour is 50 parts, the gluten powder is 35 parts, the oat flour is 15 parts, the butter is 6 parts, the sodium caseinate is 3 parts, the salt is 1.6 parts, the yeast is 1 part, the improver is 1 part, and the water is 100 parts.

6. The method for preparing a bread according to claim 2, wherein the brown rice flour is 50 parts, the gluten powder is 35 parts, the oat flour is 15 parts, the butter is 6 parts, the sodium caseinate is 3 parts, the salt is 1.6 parts, the yeast is 1 part, the improver is 1 part, and the water is 100 parts.

7. The method for preparing a bread according to claim 3, wherein the brown rice flour is 50 parts, the gluten powder is 35 parts, the oat flour is 15 parts, the butter is 6 parts, the sodium caseinate is 3 parts, the salt is 1.6 parts, the yeast is 1 part, the improver is 1 part, and the water is 100 parts.

8. The method for preparing a bread according to claim 4, wherein the brown rice flour is 50 parts, the gluten powder is 35 parts, the oat flour is 15 parts, the butter is 6 parts, the sodium caseinate is 3 parts, the salt is 1.6 parts, the yeast is 1 part, the improver is 1 part, and the water is 100 parts.

9. The method for preparing a bread according to claim 1, wherein the brown rice and oat bread has a GI value of 49.

10. The method for preparing a bread according to claim 1, wherein the dough after plating is 250 g.

11. A composite flour for making a bread, comprising the following in parts by mass: 45-55 parts of brown rice flour, 30-40 parts of gluten powder, 10-20 parts of oat flour, 3-6 parts of sodium caseinate, and 1-2 parts of improver.

12. The composite flour for making a bread according to claim 11, wherein 5-8 parts of butter, 1-2 parts of salt, 1-2 parts of yeast, and 90-100 parts of water are additionally added when making the bread using the composite flour.

13. A brown rice and oat bread recipe, comprising the following ingredients in parts by mass: 45-55 parts of brown rice flour, 30-40 parts of gluten powder, 10-20 parts of oat flour, 5-8 parts of butter, 3-6 parts of sodium caseinate, 1-2 parts of salt, 1-2 parts of yeast, 1-2 parts of improver, and 90-100 parts of water.
